(19) United States
(12) Patent Application Publication
(10) Pub. No.: US 2007/0058507 A1
(43) Pub. Date: Mar. 15, 2007

(54) Apparatus and method for controlling a recording light signal

(75) Inventors: Soo-yong Kim, Suwon-si (KR); In-ju Jang, Yongin-si (KR)

Correspondence Address: LEE & MORSE, P.C., 3141 FAIRVIEW PARK DRIVE, SUITE 500, FALLS CHURCH, VA, 22042, US

(73) Assignee: Samsung Electronics Co., Ltd.

(21) Appl. No.: 11/515,425

(22) Filed: Sep. 5, 2006

(30) Foreign Application Priority Data
Sep. 6, 2005 (KR) 10-2005-0082632

(51) Int. Cl. G11B 7/12

(52) U.S. Cl. 369/47.53

(57) ABSTRACT

A light source for use with an optical disc is controlled by comparing current operational characteristics of the light source to previous operational characteristics and obtaining optimized voltages for each stage of a writing signal when the current operational characteristics differ from the previous operational characteristics by a predetermined amount.

### BACKGROUND OF THE INVENTION

1. Field of the Invention

The present invention is related to an apparatus and method for controlling a recording light signal. More particularly, the present invention is related to an apparatus and method for controlling the recording light signal in accordance with changes in operational characteristics of a light source generating the recording light signal.

2. Description of Related Art

Light sources used in optical recording and reproducing apparatuses for recording or reproducing data on optical discs, e.g., blu ray discs (BD), compact discs (CD), digital versatile discs (DVD), high definition (HD)-DVD, have operational characteristics that may change due to a number of factors, e.g., temperature, age, humidity. Only if the optical recording and reproducing apparatus has a stable light source can data on an optical disk be faithfully reproduced.

In addressing this problem, optimum power control (OPC) has been used. For OPC to be realized, disc manufacturers store suitable recording power values in lead-in areas of recordable discs. An optical disc recording apparatus tests the suitable recording power values to obtain an optimum or target power when a disc is loaded in the optical disc recording apparatus.

FIG. 1 illustrates a block diagram of an optical recording and reading apparatus including a conventional automatic light power controller (ALPC) 5. Here, the light source controlled by the ALPC 5 is illustrated as a laser diode (LD) 2 of an optical pick-up unit 1. The optical pick-up unit 1 also includes an optical detector 3 that detects the output of the LD 2. The ALPC 5 includes a reference voltage generator 51, a comparator 52, a target power operation circuit 53, a LD driver 54 and a LD output monitor 55.

The LD output monitor samples and holds an output from the optical detector 3 and then outputs a monitor voltage Vm to the comparator 52. The reference voltage generator 51 outputs a reference voltage Vr corresponding to the target power obtained by the OPC process to the comparator 52. The comparator 52 compares the reference voltage Vr with the monitor voltage Vm and outputs a difference. The target power operational circuit 53 adds or subtracts the difference to or from a received recording signal DATA to compensate for the previous recording signal, and outputs the compensated signal as a write signal WS. The LD driver 54 converts the voltage values of the write signal WS, i.e., the compensated recording signal, into current values and drives the LD 2 with the compensated recording signal. Thus, the ALPC 100 automatically compensates for any changes in the output of the LD 2, and this of the recording light signal or write pulse WP.

FIGS. 2A-2C illustrates waveforms used in the operation of the optical recording and reading apparatus. As shown in FIG. 2A, the write signal WS includes an overdrive power, a recording power, a cooling power and a reading power. As shown in FIG. 2B, the output of the optical detector 3 in response to the write signal WS is analog, and does not exactly follow the waveform of the write signal WS. As shown in FIG. 2C, a sample pulse SP of the sample and hold signal of the LD output monitor 55 samples during stable record and read operations. Thus, the conventional ALPC 5 only compensates the recording and reading power, i.e., does not compensate the overdrive power and the cooling power. Even if the sampling frequency is increased, the conventional ALPC cannot obtain the exact value of the overdrive and cooling power. Thus, recording quality may be poor.

### SUMMARY OF THE INVENTION

The present invention is therefore directed to a method and apparatus for controlling a recording light signal, which substantially overcome one or more of the problems due to the limitations and disadvantages of the related art.

It is therefore a feature of an embodiment of the present invention to provide a method and apparatus of controlling a recording signal in accordance with changes in operational characteristics of a light source generating the recording light signal.

It is another feature of an embodiment of the present invention to provide a method and apparatus of controlling a recording signal for an entire write signal, including during operations outside reading and recording operations.

It is yet another feature of an embodiment of the present invention to provide a method and apparatus of controlling a recording signal during overdrive.

It is still another feature of an embodiment of the present invention to provide a method and apparatus of controlling a recording signal during cooling.

At least one of the above and other features and advantages of the present invention may be realized by providing a method of controlling a light source for use with an optical disc, including comparing current operational characteristics of the light source to previous operational characteristics and obtaining optimized voltages for each stage of a writing signal when the current operational characteristics differ from the previous operational characteristics by a predetermined amount.

Obtaining the optimized voltages may include performing optimum power control in accordance with information for the optical disc. The method may include switching from a recording mode to a reading mode before performing the optimum power control and returning to the recording mode after performing the optimum power control.

The method may include storing an address when switching from recording mode to reading mode. The method may include resuming recording at a position adjacent, e.g., immediately adjacent, and subsequent to the address when returning to recording mode.

Information for the optical disc stored on the optical disc may be read by moving an optical pick-up through which the light output from the light source is provided to the optical disc and the optical disc relative to one another to provide the light at an address where the information is stored.

The method may further include evaluating current operational characteristics differing from the previous operational characteristics by the predetermined amount before obtaining the optimized voltage. Evaluating current operational characteristics may include determining whether a write quality beta value for current operational characteristics is within a predetermined range. The operational characteristics may be a difference in a voltage needed to realize at least one of a read power and a write power.

At least one of the above and other features and advantages of the present invention may be realized by providing an apparatus for controlling light from a light source for use with an optical disc including a light source characteristic monitor for monitoring current operational characteristics of the light source relative to previous operational characteristics and a controller for controlling light output from the light source by obtaining an optimized voltage for the current operational characteristics when the current operational characteristics differ from the previous operational characteristics by a predetermined amount.

The light source characteristics monitor may output a first control signal to the controller when the current operational characteristics differ from the previous operational characteristics by the predetermined amount and the controller may initiate an optimum power control to determine a new optimized voltage. The controller may output a third control signal to a moving unit moving an optical pick-up through which light output from the light source is provided to the optical disc and the optical disc relative to one another to provide light at an address where information for the optical disc is stored.

The light source characteristic monitor may monitor a difference in a voltage needed to realize at least one of a read power and a write power. The controller may obtain the optimized voltage by performing an optimum power control process in accordance with information for the optical disc. The controller may switch an optical pick-up through which light output from the light source is provided to the optical disc from a recording mode to a reading mode before performing the optimum power control and returns the optical pick-up to the recording mode after performing the optimum power control. The controller may store an address when switching the optical pick-up from the recording mode to the reading mode. The controller may resume recording at a position adjacent, e.g., immediately adjacent, and subsequent to the address when returning the optical pick-up to the recording mode. The controller may evaluate current operational characteristics differing from the previous operational characteristics by the predetermined amount before obtaining the optimized voltage. The controller may evaluate current operational characteristics by determining whether a write quality beta value for current operational characteristics is within a predetermined range. The controller may determine a corresponding voltage for temporal regions in a write signal that cannot be directly measured from the current operational characteristics.

### BRIEF DESCRIPTION OF THE DRAWINGS

The above and other features and advantages of the present invention will become more apparent to those of ordinary skill in the art by describing in detail exemplary embodiments thereof with reference to the attached drawings in which:

FIG. 1 illustrates a block diagram of an optical recording and reading apparatus with a conventional automatic light power controller;

FIGS. 2A-2C illustrate waveforms used in the operation of the optical recording and reading apparatus of FIG. 1;

FIG. 3 illustrates a block diagram of optical recording and reading apparatus including an automatic light power controller(ALPC) and a threshold light characteristic controller (TLCC) in accordance with an embodiment of the present invention;

FIG. 4 illustrates a block diagram of the relationship between the ALPC and the TLCC;

FIG. 5 illustrates how the characteristics of the light source vary over time;

FIG. 6 illustrates the recording operation in accordance with variation of characteristics of the light source;

FIG. 7 illustrates a flow chart for controlling a recording light signal in accordance with an embodiment of the present invention; and

FIG. 8 illustrates a flowchart for obtaining an optimized power in accordance with an embodiment of the present invention.

### DETAILED DESCRIPTION OF THE INVENTION

Korean Patent Application No. 10-2005-0082632, filed on Sep. 6, 2005, in the Korean Intellectual Property Office, and entitled: “Apparatus and Method for Controlling a Recording Light Signal,” is incorporated by reference herein in its entirety.

The present invention will now be described more fully hereinafter with reference to the accompanying drawings, in which exemplary embodiments of the invention are shown. The invention may, however, be embodied in different forms and should not be construed as limited to the embodiments set forth herein. Rather, these embodiments are provided so that this disclosure will be thorough and complete, and will fully convey the scope of the invention to those skilled in the art. In the figures, the dimensions of layers and regions are exaggerated for clarity of illustration. Like reference numerals refer to like elements throughout

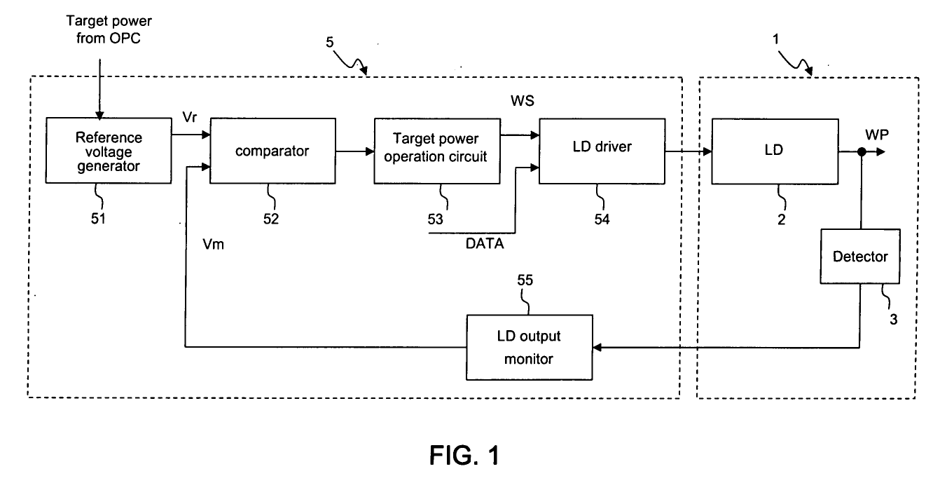

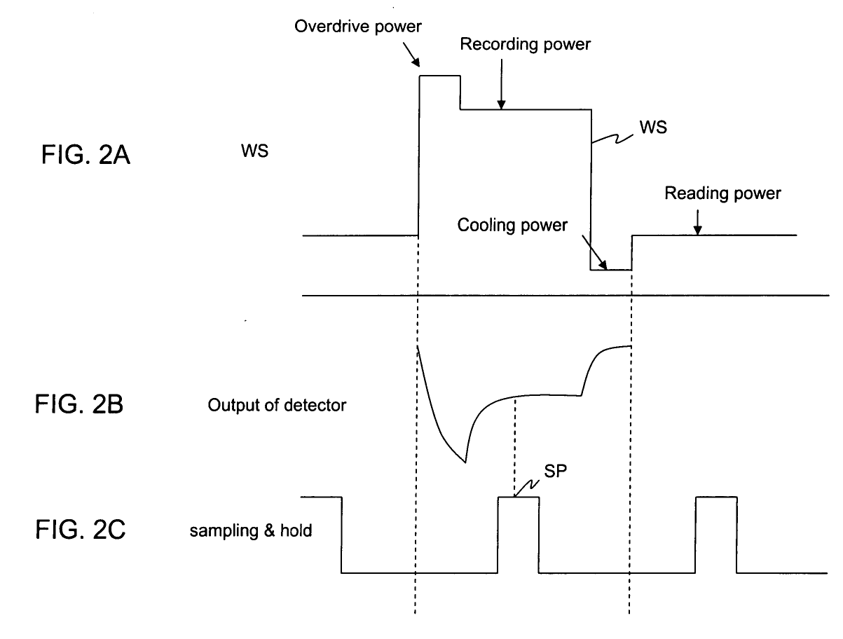

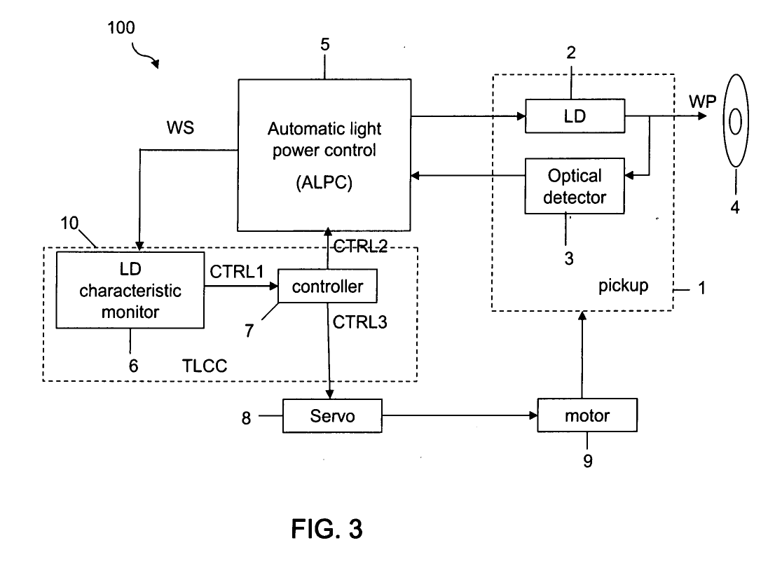

FIG. 3 illustrates a block diagram of an optical recording system 100 in accordance with an embodiment of the present invention. The system 100 includes the ALPC 5 operating as the conventional ALPC 5 of FIG. 1, the optical pick-up 1, a servo 8, a motor 9 and a threshold light characteristic controller (TLCC) 10. The optical pick-up 1 includes the LD 2 and the optical detector 3. The ALCC 10 includes a LD characteristic monitor 6 and a controller 7. The servo 8 and the motor 9 are used for moving output of the LD 2 and a recording medium 4 relative to one another.

The ALPC 5 outputs the write signal WS to the LD characteristic monitor 6 of the TLCC 10. When the variation of LD characteristics is outside a predetermined range, the LD characteristic monitor 6 outputs a controller signal CTRL1 to the controller 7 to indicate that characteristics of the LD 2 have changed. The predetermined range may be experimentally determined. The LD characteristic being monitored by the LD characteristic monitor 6 may be one or more of a voltage needed to realize a read power, a voltage needed to realize a write power and a write quality beta value.

When the controller 7 of the TLCC 10 receives CTRL1, the controller 7 may stop the writing operation, i.e., converts the recording mode into the reading mode. The controller 7 may store the position or address where the writing operation was stopped. The controller 7 may output CTRL2 to the ALPC 5 to indicate writing has stopped. The controller 7 may output CTRL3 to the servo 8 to move the optical pickup to the lead-in area where the target power is stored. The controller 7 then runs the OPC, and a new target voltage based thereon is stored in the reference voltage generator. The controller 7 may evaluate a resultant write power beta value to insure it is within, i.e., equal to or less than, the original write power beta value of the starting OPC before the new target voltage power is output to the reference voltage generator. The controller 7 may then output CTRL3 to the servo 8 to return to the position where the writing operation was stopped. The controller 7 then may convert back from the reading mode to the record mode and resume the writing operation from the next position from where the writing operation was stopped. The controller 7 may output CTRL2 to the ALPC 5 to indicate the writing operation has resumed.

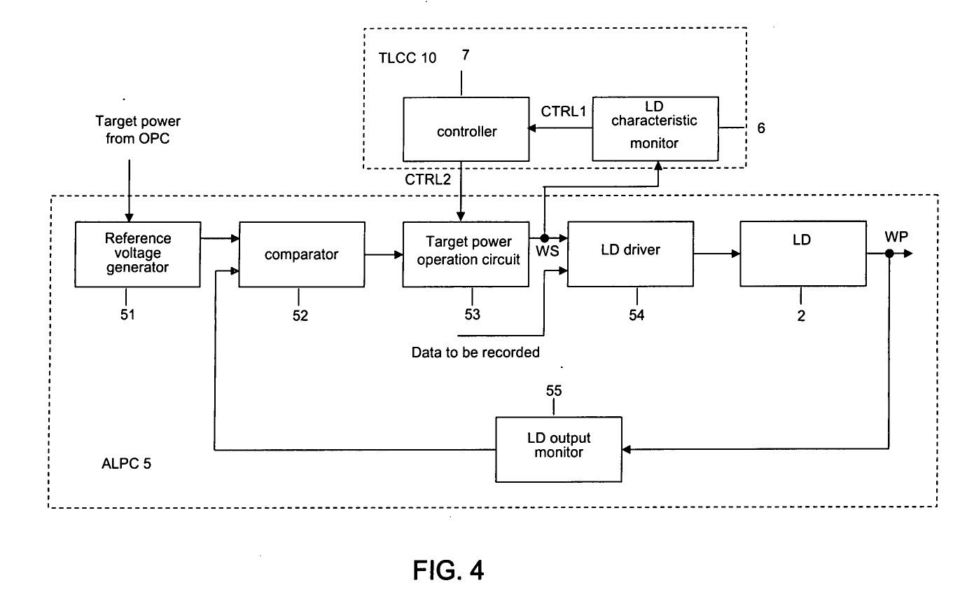

FIG. 4 illustrates a block diagram of the relationship between the ALPC 5 and the TLCC 10. As can be seen therein, the ALPC 5 includes the reference voltage generator 51, the comparator 52, the target power operation circuit 53, the LD drive 54 and the LD output monitor 55, operating as discussed above in relation to FIG. 1. The LD characteristics monitor 6 receives the same write signal WS as the LD driver 54, and the controller 7 outputs CTRL2 to the target power operation circuit 53 to indicate start and stop of the writing operation.

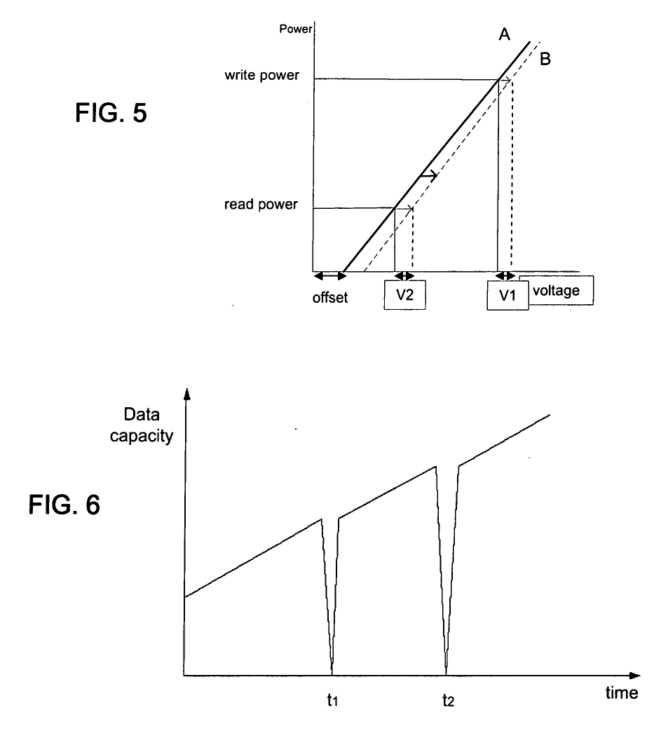

FIG. 5 illustrates a plot of the characteristic slope of the LD 2. Line A indicates the initial operating characteristics of the LD 2 and line B indicates operational characteristics after a period of time has elapsed. As can be seen in FIG. 5, line A and line B have different offsets and slopes. Thus, the voltage V2, corresponding to the read power, and the voltage V1, corresponding to the write power, varies over time. FIG. 5 is just used to indicate that the output of the LD has changed sufficiently to require OPC. When this has changed enough, i.e., due to temperature or other environmental factors, correcting only the read and write power may not be sufficient to insure proper operation, and additional compensation for other portions of the write signal, e.g., overdrive and/or cooling power, may be needed. However, since OPC is time consuming, there is a trade-off between running the OPC and potential operational errors.

FIG. 6 illustrates the recording operation in accordance with variation of characteristics of the light source in accordance with an embodiment of the present invention. At times t1, t2, a variation of the LD characteristics is outside the predetermined range. Thus, the recording operation is ceased, and the data capacity does not increase. After stopping the recording operation, OPC is performed. After OPC is performed, the recording operation may resume and data capacity may increase.

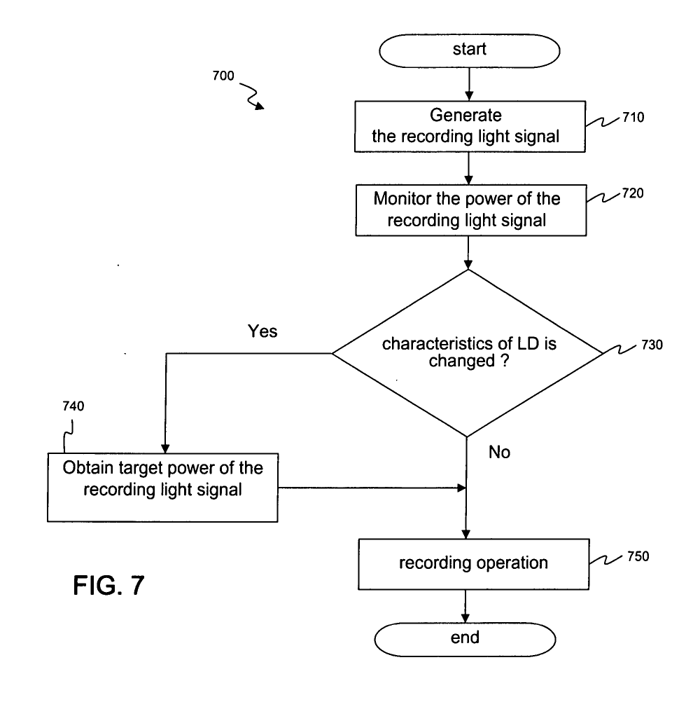

FIG. 7 illustrates a flow chart of a method of controlling a light source in accordance with an embodiment of the present invention. The light source outputs the recording light signal (710). The power of the recording light signal is monitored (720). The characteristics of the light source are monitored to determine if they vary outside the predetermined range (730). If not, the recording operation continues (750). If so, the OPC is performed (740) and then the recording operation is resumed (750).

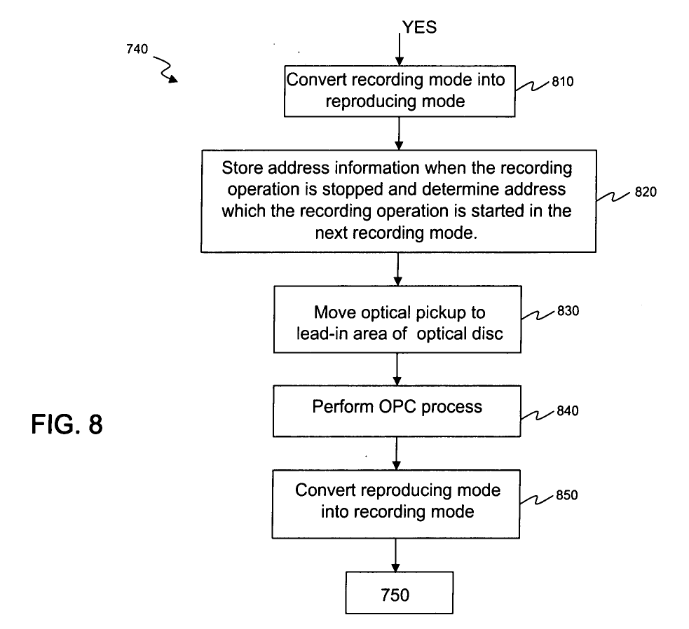

FIG. 8 illustrates a flow chart for the OPC (740) of FIG. 7 in accordance with an embodiment of the present invention. First, the recording mode is switched into the reproducing or reading mode (810). The address information regarding where the recording operation has been stopped is stored and the address at which the recording operation is to resume after OPC is determined (820). The optical pickup is then moved to the lead-in area of the optical disc (830) and the OPC process is performed (840). Once the OPC is completed, the recording mode is resumed (850).

Thus, in accordance with the present invention, if the characteristics of a light source used for recording are changed, they may be compensated even in regions where the output cannot be directly measured. In other words, if the write signal WS changes by more than some predetermined amount, OPC may be performed and the reference voltage V2 updated to insure accurate recording.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A method of controlling a light source for use with an optical disc, the method comprising:
comparing current operational characteristics of the light source to previous operational characteristics; and
obtaining optimized voltages for each stage of a writing signal when the current operational characteristics differ from the previous operational characteristics by a predetermined amount.

2. The method as claimed in claim 1, wherein obtaining the optimized voltages comprises performing optimum power control in accordance with information for the optical disc.

3. The method as claimed in claim 2, further comprising
switching from a recording mode to a reading mode before performing the optimum power control; and
returning to the recording mode after performing the optimum power control.

4. The method as claimed in claim 3, further comprising:
storing an address when switching from recording mode to reading mode.

5. The method as claimed in claim 4, further comprising resuming recording at a position adjacent and subsequent to the address when returning to recording mode.

6. The method as claimed in claim 5, wherein the position is immediately adjacent.

7. The method as claimed in claim 2, further comprising, when information for the optical disc is stored on the optical disc:
moving an optical pick-up through which the light output from the light source is provided to the optical disc and the optical disc relative to one another to provide the light at an address where the information is stored.

8. The method as claimed in claim 1, further comprising evaluating current operational characteristics differing from the previous operational characteristics by the predetermined amount before obtaining the optimized voltage.

9. The method as claimed in claim 8, wherein evaluating current operational characteristics comprises determining whether a write quality beta value for current operational characteristics is within a predetermined range.

10. The method as claimed in claim 1, wherein the operational characteristics are a difference in a voltage needed to realize at least one of a read power and a write power.

11. An apparatus for controlling light from a light source for use with an optical disc, the apparatus comprising:
a light source characteristic monitor for monitoring current operational characteristics of the light source relative to previous operational characteristics; and
a controller for controlling light output from the light source by obtaining an optimized voltage for the current operational characteristics when the current operational characteristics differ from the previous operational characteristics by a predetermined amount.

12. The apparatus as claimed in claim 11, wherein the light source characteristic monitor outputs a first control signal to the controller when the current operational characteristics differ from the previous operational characteristics by the predetermined amount and the controller initiates optimal power control to generate a current optimized voltage.

13. The apparatus as claimed in claim 12, wherein the controller further outputs a third control signal to a means for moving an optical pick-up through which light output from the light source is provided to the optical disc and the optical disc relative to one another to provide light at an address where information for the optical disc is stored.

14. The apparatus as claimed in claim 11, wherein the light source characteristic monitor monitors a difference in a voltage needed to realize at least one of a read power and a write power.

15. The apparatus as claimed in claim 11, wherein the controller obtains the optimized voltage by performing an optimum power control process in accordance with information for the optical disc.

16. The apparatus as claimed in claim 15, wherein the controller further switches an optical pick-up through which light output from the light source is provided to the optical disc from a recording mode to a reading mode before performing the optimum power control and returns the optical pick-up to the recording mode after performing the optimum power control.

17. The apparatus as claimed in claim 16, wherein the controller further stores an address when switching the optical pick-up from the recording mode to the reading mode.

18. The apparatus as claimed in claim 17, wherein the controller further resumes recording at a position adjacent and subsequent to the address when returning the optical pick-up to the recording mode.

19. The apparatus as claimed in claim 18, wherein the position adjacent is immediately adjacent.

20. The apparatus as claimed in claim 11, wherein the controller evaluates current operational characteristics differing from the previous operational characteristics by the predetermined amount before obtaining the optimized voltage.

21. The apparatus as claimed in claim 20, wherein the controller evaluates current operational characteristics by determining whether a write quality beta value for current operational characteristics is within a predetermined range.

22. The apparatus as claimed in claim 11, wherein the controller determines a corresponding voltage for temporal regions in a write signal that cannot be directly determined from the current operational characteristics.
